(19) United States
(12) Patent Application Publication
(10) Pub. No.: US 2004/0027252 A1
(43) Pub. Date: Feb. 12, 2004

(54) Coupling signals to flowlines

(76) Inventor: Steven Martin Hudson, Dorset (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/450,466

(22) PCT Filed: Dec. 13, 2001
(86) PCT No.: PCT/GB01/05519

(30) Foreign Application Priority Data
Dec. 15, 2000 (GB) 0030661.3

(51) Int. Cl. G01V 3/00

(52) U.S. Cl. 340/855.1; 340/854.8

(57) ABSTRACT

Coupling apparatus for allowing transmission of electrical signals between a flowline (1) and a communications unit (4). The coupling apparatus comprises first (5) and second (8) portions of magnetic material. The first portion is arranged to receive the second portion and at least partially defines a flowline receiving aperture. The first and second portions (5,8) together form a magnetic circuit around the aperture and the second portion carries a winding (9) arranged for electrical connection to the communications unit (4). The winding links with the magnetic circuit when the second portion (8) is received in the first (5) such that an alternating current in the winding will generate a corresponding current in a flowline disposed in the aperture and vice versa. The arrangement allows the first portion to be permanently mounted on a flowline and the second portion to be inserted in situ.

This invention relates to coupling signals to flowlines. In particular the application relates to apparatus for facilitating the communication of data to and from flowlines in the oil and gas industry and particularly where the flowline is the production string in a well.

The applicant has existing systems for the transmission of data along the metallic structure of flowlines in general and wells in particular.

One of the methods used to inject signals onto a flowline or extract signals from a flowline is to use a form of inductive coupling. In this coupling, the flowline and associated return, typically earth, form a single turn winding of a transformer. The remainder of the transformer comprises a generally toroidal magnetic core disposed around the flowline and windings which are connected to a suitable communications unit for transmitting and/or receiving signals. This arrangement is such that alternating signals in the windings around the core induce corresponding signals in the flowline and vice versa.

A problem with such a coupling method is that it is difficult or impossible to mount a toroidal core onto a flowline once it is installed. This problem is particularly acute in a downhole situation. In existing systems, the core is mounted onto a flowline, together with the communications unit and any associated batteries, sensors etc, before installation of the flowline. The core itself can give a long operating life but this may not be true of the components which are coupled to the Bowline via the core.

It has occurred to the applicants that a way to solve this problem is to have a communications module which can be attached to and removed from the core. However, once this has been realised it leaves a problem of how to achieve a reliable and effective connection between the module and the remainder of the system which can withstand the harsh conditions of the environment in which the flowline is disposed. It will be appreciated that, where the flowline is a downhole production string, the core and module must exist in a high pressure zone which may be packed with brine.

It is an object of this invention to provide means for facilitating signal coupling between a flowline and a communications unit which alleviate at least some of the problems associated with the prior art.

According to a first aspect of the present invention there is provided coupling apparatus for allowing transmission of electrical signals between a flowline and a communications unit, the coupling apparatus comprising first and second portions of magnetic material, the first portion being arranged to receive the second portion and at least partially defining a flowline receiving aperture, the first and second portions together forming a magnetic circuit around the aperture and the second portion carrying a winding arranged for electrical connection to a communications unit, the winding linking with the magnetic circuit when the second portion is received in the first such that an alternating current in the winding will generate a corresponding current in a flowline disposed in the aperture and vice versa.

According to a second aspect of the present invention there is provided a communications system for communication between a communication unit and a flowline, the system comprising a coupling component and a communications module, the coupling component comprising a first portion of magnetic material and the communications module comprising a second portion of magnetic material, the first portion being arranged to receive the second portion and at least partially defining a flowline receiving aperture, the first and second portions together forming a magnetic circuit around the aperture and the second portion carrying a winding electrically connected to a communications unit in the communications module, the winding linking with the magnetic circuit when the second portion is received in the first such that an alternating current in the winding will generate a corresponding current in a flowline disposed in the aperture and vice versa.

According to a third aspect of the present invention there is provided a coupling component suitable for use in coupling apparatus for allowing transmission of electrical signals between a flowline and a communications unit, the component comprising a first portion of magnetic material defining a void for receiving a second portion of magnetic material and at least partially defining an aperture for receiving a flowline, the first portion forming at least part of a magnetic circuit around the flowline receiving aperture.

According to a fourth aspect of the present invention there is provided a communications module suitable for use with coupling apparatus of a type having a first portion of magnetic material for receiving a flowline and arranged for facilitating transmission of electrical signals between a flowline and a communications unit, the module comprising a communications unit, a second portion of magnetic material and a winding which is disposed around the second portion of magnetic material and electrically connected to the communications unit.

The first portion of magnetic material may completely surround the flowline receiving aperture to form the magnetic circuit. Preferably however, the first portion incompletely surrounds the flowline receiving aperture, and the second portion, when inserted, completes the magnetic circuit.

The first portion of magnetic material may be generally toroidal, the flowline receiving aperture being a central aperture of the toroid.

In this application the expression generally toroidal is used to mean a three dimensional shape which is ringlike or looplike and thus at least partially surrounds a central aperture. However, there is no restriction to the ring or loop being circular and nor is there a restriction on the shape of the cross-section of the body forming the loop or ring. Thus, for example, the loop itself might be square and the cross-section of the body forming the loop might be square. Similarly the internal perimeter of the toroidal shape may not be the same shape as the external perimeter of the toroidal shape. The internal perimeter may be shaped to fit a flowline and the external perimeter may be dictated by other factors.

The first portion may be of an incomplete toroidal shape and the second portion may be arranged to complete the toroidal shape. Preferably the internal perimeter of the toroidal shape is generally cylindrical. This is desirable so that the magnetic portions can closely fit and surround a cylindrical Bowline.

The first portion may be arranged so that its cross-sectional area in planes perpendicular to the path of the magnetic circuit is substantially constant.

Preferably the second portion is removably insertable into the first portion. A void in the first portion for receiving the second portion of magnetic material may be generally cylindrical. The second portion may be generally cylindrical. Preferably the second portion achieves intimate contact with the first portion along a substantial part of its length when disposed in the void. There may be an interference fit between the first and second portions. The second portion and the void may be tapered to encourage close fitting.

The second portion may be disposed in a casing of nonmagnetic material. In such a case, a layer of this material may be present between the first and second portions when the second portion is disposed in the first.

The communications module may comprise a casing which may be of non magnetic material and the second portion may be disposed in that casing. The communications unit may also be housed in the casing.

In other embodiments, although a casing may be provided to house the communications unit, the second portion may be exposed. This can facilitate close contact between the first and second portions of magnetic material.

Each of the arrangements above facilitates signal coupling between a communications unit and a flowline before or after the flowline has been installed and gives a robust and reliable connection.

Embodiments of the invention will now be described by way of example only with reference to the accompanying drawings in which:

FIG. 1 is a schematic side view of a communications system arranged to allow the transmission of signals between a flowline and a communications unit;

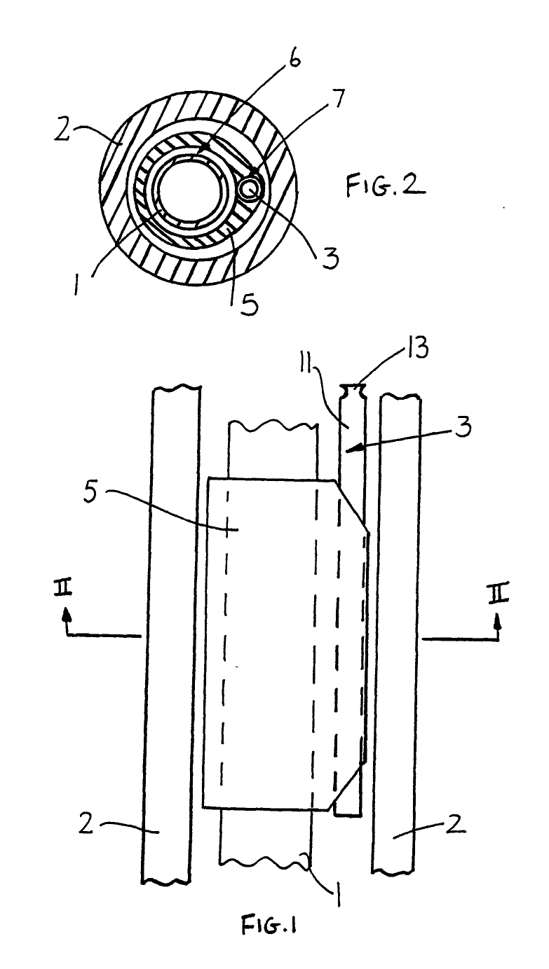

FIG. 2 is a schematic section on line II-II of the communications system shown in FIG. 1;

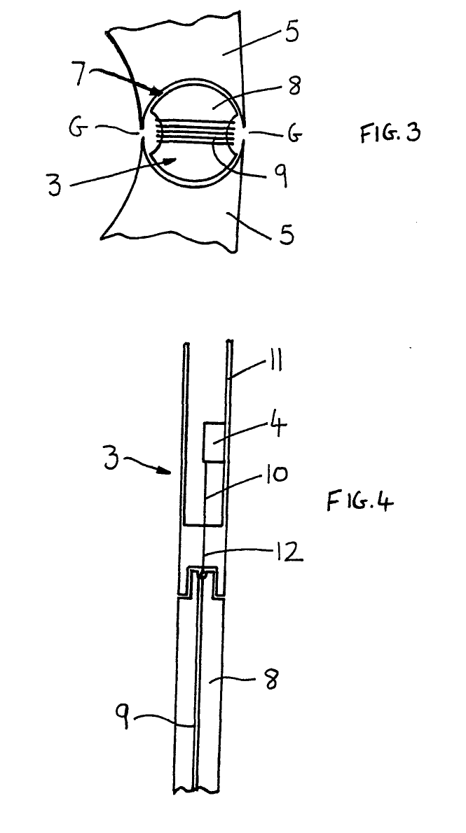

FIG. 3 is a partial view of the communications system shown in FIGS. 1 and 2 which shows more detail of the arrangement of two portions of magnetic material in the communications system; and

FIG. 4 shows part of a communications module of the communications system shown in FIGS. 1 and 2.

FIGS. 1 and 2 show a communications system for allowing signals to be transmitted to and from the metallic structure of a well. The metallic structure comprises a central flowline or production string 1 and a surrounding casing 2. A communications module 3 which houses a communication unit 4 (see FIG. 4) is provided adjacent to the string 1. This application relates to the components and apparatus required to achieve signal coupling between the communications unit 4 provided in the communications module 3 and the string 1. The form of signals transmitted, the data to which the signals relate, and the way in which the signals are propagated towards and away from the communication module 3 are not the subject of this application and will not be discussed in detail.

In the system of the present application, an inductive coupling is used to allow signals to be transmitted in both directions between the string 1 and the communications unit 4. This inductive coupling is facilitated by the provision of a first portion of magnetic material 5 which defines an aperture 6 through which the flowline 1 passes.

This first portion of magnetic material 5 almost completely surrounds the production string 1. The first portion of magnetic material 5 is of generally toroidal shape, more specifically it has the general form of a thick walled hollow cylinder. Thus the internal perimeter or surface of the first portion of magnetic material 5 is generally cylindrical and closely matches the outer surface of the production string 1. Although a significant spacing is shown in FIG. 2 between the outer surface of the production string 1 and the inner surface of the first portion of magnetic material 5 this is for the aid of clarity in the drawings. In actual practice the first portion of magnetic material 5 will closely fit the production string 1. However, a layer of non-magnetic material (not shown) is provided between the outer surface of the production string 1 and the inner surface of the first portion of magnetic material 5.

The outer surface of the first portion of magnetic material 5 is distorted from its cylindrical form in order to provide a second aperture 7 which is arranged to receive the communications module 3.

The shape of the first portion of magnetic material 5 in the present embodiment is chosen to maximise efficient use of space within the casing 2. The size, and in particular, the diameter of the communications module 3 is dictated by its need to house appropriate components. Allowing sufficient room for the communications module 3 means that the radial thickness of the first portion of magnetic material 5 must be reduced at locations away from the communications module 3.

The shape of the first portion of magnetic material 5 is chosen so that its cross sectional area in generally radial planes (i.e. those planes which will be perpendicular to any flux flowing around the first portion of magnetic material 5) are substantially constant in order to provide optimum efficiency. To achieve this, the axial length of the first portion of magnetic material 5 is tapered in those regions where its radial width is increased, i.e. in the region adjacent to the communications module 3, as can be seen in FIG. 1.

As most clearly shown in FIGS. 3 and 4, the communications module 3 comprises a second portion of magnetic material 8. The second portion of magnetic material 8 is generally cylindrically and is dimensioned to fit closely within the second aperture 7 defined by the first portion of magnetic material 5. It should be noted that although a significant spacing is shown between the second portion of magnetic material 8 and the first portion of magnetic material 5 this is for the sake of clarity in the drawings. In practice these two parts will closely fit together and ideally will form an interference fit with one another. In some cases the aperture 7 and second portion of magnetic material 8 may be suitably tapered to encourage a close fit.

It should be noted that the first portion of magnetic material 5, as shown in FIG. 3, does not form a complete toroid or thick walled hollow cylinder. There are gaps G at either side of the aperture 7 so that there is no short cutting path for magnetic flux.

The second portion of magnetic material 8 carries a winding or windings 9 which surround the second portion of magnetic material 8 in a longitudinal direction. Cables 10 provide connections between the ends of the winding or windings 9 and the communications unit 4.

In this embodiment, the communications module 3 comprises a pressure proof housing 11 in which the communications unit 4 and other desired components such as batteries and sensors are disposed. However, the second portion of magnetic material 9 is not disposed within the pressure proof housing 11 but rather has its surfaces exposed to allow direct contact with the first portion of magnetic material 5. The second portion of magnetic material 8 is mounted into the end of the pressure proof housing 11 by suitable means, such as interengaging threads. The connecting cables 10 between the windings 9 and communications unit 4 pass through pressure proof seals 12 disposed in the housing 11.

In alternatives, the second portion of magnetic material 8 may be disposed within the pressure proof housing 11. In such cases, the apparatus can still function effectively provided that the pressure proof housing 11 is of non-magnetic material. Otherwise a short cutting path for magnetic flux would be provided.

The communications module 3 is arranged to be removably insertable into the aperture 7 defined by the first portion of magnetic material S. The communications module 3 is provided with attachment means 13 which can be used to deploy and remove the communications module 3 using standard wireline techniques.

The fact that the communications module 3 can be replaced whilst leaving the first portion of magnetic material 5 located around the production string 1 allows the lifetime of the communications system as a whole to be significantly increased. The first portion of magnetic material 5 will be installed on the production string 1 before it is inserted into the well and a large number of communication modules 3 may be used successively without replacing the first portion of magnetic material 5 or removing the production string 1 from the well.

It might, for example, be desirable to remove the communications module 3 because it is suffering from a malfunction or because its batteries have run out. Because the connection between the first and second portions of magnetic material 5 and 8 relies only on a simple mechanical fit between these two portions, it is an extremely robust and hard wearing system.

When the communications module 3 is in its operative position, inserted into the aperture 7 in the first portion of magnetic material 5, the first and second portions of magnetic material 5, 8, together form a complete magnetic circuit around the production string 1. Further, the windings 9 around the second portion of magnetic material 8 link with this magnetic circuit. This means that when an alternating current is caused to flow through the windings 9, by the communications unit 4, the two portions of magnetic material 5, 8 act as the core of a transformer and the production string 1 and its associated return act as a single turn secondary coil so that electrical signals will be induced onto the production string 1. Similarly, if alternating electrical signals are flowing in the production string 1 this acts as a primary coil so that corresponding electrical signals are generated in the windings 9 as a secondary coil and can be detected by the communications unit 4.

1. Coupling apparatus for allowing transmission of electrical signals between a flowline and a communications unit, the coupling apparatus comprising first and second portions of magnetic material, the first portion being arranged to receive the second portion and at least partially defining a flowline receiving aperture, the first and second portions together forming a magnetic circuit around the aperture and the second portion carrying a winding arranged for electrical connection to a communications unit, the winding linking with the magnetic circuit when the second portion is received in the first such that an alternating current in the winding will generate a corresponding current in a flowline disposed in the aperture and vice versa wherein the first portion is arranged to allow the introduction of the second portion by movement in a direction which is substantially parallel to a central axis of the flowline receiving aperture.

2. Coupling apparatus according to claim 1, in which the first portion defines a void for receiving the second portion.

3. Coupling apparatus according to claim 2 in which the void has a central axis which is substantially parallel to the central axis of the flowline receiving aperture.

4. Coupling apparatus according to claim 2 or claim 3 in which the void arranged to receive the second portion is an aperture.

5. Coupling apparatus according to any one of claims 2 to 4 in which the void is arranged to substantially surround the second portion.

6. Coupling apparatus according to any preceding claim in which the first portion of magnetic material incompletely surrounds the flowline receiving aperture, and the second portion of magnetic material, when inserted, completes the magnetic circuit.

7. Coupling apparatus according to any preceding claim in which the first portion of magnetic material is generally toroidal, the flowline receiving aperture being a central aperture of the toroid.

8. Coupling apparatus according to claim 7 in which the first portion of magnetic material is of an incomplete toroidal shape and the second portion is arranged to complete the toroidal shape.

9. Coupling apparatus according to any preceding claim in which the first portion of magnetic material is arranged so that its cross-sectional area in planes perpendicular to the path of flux when flowing in the magnetic circuit is substantially constant.

10. Coupling apparatus according to any preceding claim in which the second portion is removably insertable into the first portion.

11. Coupling apparatus according to any preceding claim when dependent on claim 2 in which the void in the first portion for receiving the second portion of magnetic material is generally cylindrical, the second portion is generally cylindrical, and the second portion achieves intimate contact with the first portion when disposed in the void.

12. Coupling apparatus according to claim 11 in which the second portion and the void are tapered to encourage close fitting.

13. A communications system for communication between a communication unit and a flowline, the system comprising a coupling component and a communications module, the coupling component comprising a first portion of magnetic material and the communications module comprising a second portion of magnetic material, the first portion being arranged to receive the second portion and at least partially defining a flowline receiving aperture, the first and second portions together forming a magnetic circuit around the aperture and the second portion carrying a winding electrically connected to a communications unit in the communications module, the winding linking with the magnetic circuit when the second portion is received in the first such that an alternating current in the winding will generate a corresponding current in a flowline disposed in the aperture and vice versa wherein the first portion is arranged to allow the introduction of the second portion by movement in a direction which is substantially parallel to a central axis of the flowline receiving aperture.

14. A communications system according to claim 13 in which the communications module comprises a casing in which the communications unit is housed.

15. A communications system according to claim 14 wherein, although a casing is provided to house the communications unit, the second portion of magnetic material is exposed.

16. A coupling component for use in coupling apparatus for allowing transmission of electrical signals between a flowline and a communications unit, the component comprising a first portion of magnetic material defining a void for receiving a second portion of magnetic material and at least partially defining an aperture for receiving a flowline, the first portion being arranged for forming at least part of a magnetic circuit around the flowline receiving aperture, wherein the flowline receiving aperture has a central axis and the void has a central axis which is substantially parallel to the central axis of the flowline receiving aperture whereby a second portion may be introduced into the void by movement in a direction which is substnatially parallel to the central axis of the flowline receiving aperture.

17. A communications module for use in coupling apparatus of a type having a first portion of magnetic material for receiving a flowline and arranged for facilitating transmission of electrical signals between a flowline and a communications unit, the module comprising such a communications unit, a second portion of magnetic material and a winding which is disposed around the second portion of magnetic material and electrically connected to the communications unit.
